(19) United States
(12) Patent Application Publication
(10) Pub. No.: US 2008/0062045 A1
(43) Pub. Date: Mar. 13, 2008

(54) COMMUNICATION DEVICE WITH A LOW PROFILE ANTENNA

(75) Inventors: Carlo Dinallo, Plantation, FL (US); Giorgi Bit-Babik, Sunrise, FL (US); Paul Morningstar, North Lauderdale, FL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/530,255

(22) Filed: Sep. 8, 2006

(51) Int. Cl. H01Q 1/38

(52) U.S. Cl. 343/700 MS; 343/702

(57) ABSTRACT

An apparatus is disclosed for a communication device (100) with a low profile antenna (102). An apparatus that incorporates teachings of the present invention may include, for example, a communication device having an antenna coupled to a communication circuit, and a controller that manages operations thereof. The antenna can have a ground structure (201), an active conductor (206) supported on the ground structure by a first insulating spacer (410), a parasitic conductor (208) supported on the ground structure by a second insulating spacer (410), a first slot (210) between the active and parasitic conductors forming a coupling region, first and second conductors (404-406) coupling the ground structure to the active and parasitic conductors near the coupling region, and a signal feed conductor (214) coupling to the active conductor near the coupling region. Additional embodiments are disclosed.

### FIELD OF THE DISCLOSURE

This invention relates generally to antennas, and more particularly to a communication device with a low profile antenna.

### BACKGROUND

As wireless devices become exceedingly slimmer, common antennas such as a Planar Inverted “F” Antenna (PIFA) design becomes impractical for use in such slim devices due to its inherent height requirements.

A need therefore arises for a communication device with a low profile antenna.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present disclosure.

FIG. 1 depicts an exemplary embodiment of a communication device;

FIG. 2 depicts an exemplary embodiment of a substrate supporting components of the communication device;

FIGS. 3-4 depict exemplary top and bottom perspective views of the corner of the substrate of FIG. 2.

FIG. 5 depicts a spectral performance of an antenna of the communication device; and

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

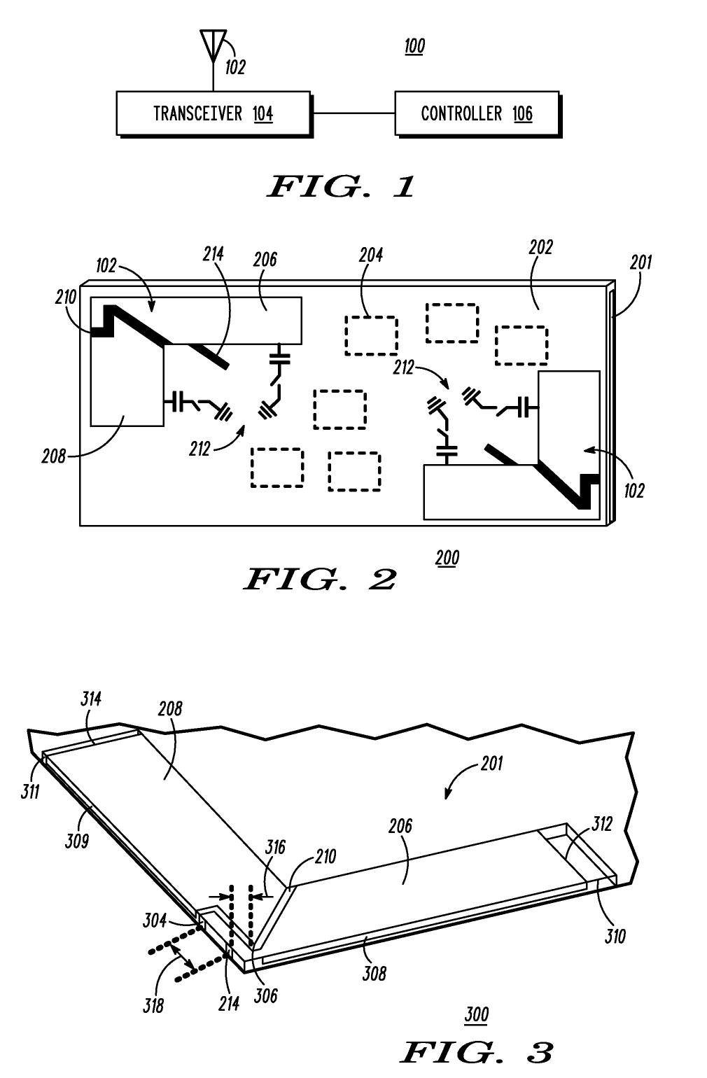

FIG. 1 depicts an exemplary embodiment of a communication device 100. The communication device 100 comprises an antenna 102, coupled to a communication circuit embodied as a transceiver 104, and a controller 106. The transceiver 104 utilizes technology for exchanging radio signals with a radio tower or base station of a wireless communication system according to common modulation and demodulation techniques. The controller 106 utilizes computing technology such as a microprocessor and/or a digital signal processor with associated storage technology (such as RAM, ROM, DRAM, or Flash) for processing signals exchanged with the transceiver 104 and for controlling general operations of the communication device 100.

FIG. 2 depicts a plan view of an embodiment of the antenna 102 of the communication device 100 supported by a substrate such as a printed circuit board (PCB) 202. A ground structure 201 such as a ground plane of the antenna system 102 is included as one layer of the PCB 202 extending throughout most of the PCB 202 including a bottom portion of the antenna 102. For illustration purposes only, the ground structure 201 will be referred to herein as ground plane 201. Alternatively, the ground plane 201 can be arranged in several layers of the PCB 202 with similar extensions throughout the PCB 202. The PCB 202 can be used to support and interconnect other electrical components 204 of the communication device 100 such as the transceiver 104 and the controller 106. For either of the foregoing embodiments, the PCB 202 can be a rigid (e.g., FR-4) or flexible (e.g., Kapton™ trademark of DuPont) substrate.

In the illustration of FIG. 2, two instances of the antenna 102 are presented. In this embodiment one of the antennas 102 can serve as transmission antenna while the other serves as a reception antenna. This is especially useful when the operating frequency of transmit and receive signals are far enough from each other that the operating bandwidth of a single antenna cannot support both frequency bands. In cases where the receive and transmit frequencies are within the operating frequency of the antenna 102, a single instance of the antenna can be used as a transceiver antenna.

From a top view, the antenna 102 comprises an active elongated flat conductor 206 (herein referred to as active conductor 206) supported above the ground plane 201 by way of an insulating spacer 310, which may be, for example, a dielectric layer 310 identified where it is exposed in FIG. 3. The antenna 102 further includes a parasitic elongated flat conductor 208 (herein referred to as parasitic conductor 208) also supported above the ground plane 201 by way of an insulating spacer 311. The active and parasitic conductors 206-208 are separated by a slot 210 of insulating material such as a dielectric or air thereby forming a gap and a corresponding electromagnetic coupling region. The gap of slot 210 can have a uniform separation (a uniform geometry) but need not be. Under a controlled design, a uniform or non-uniform slot 210 can produce similar spectral performances.

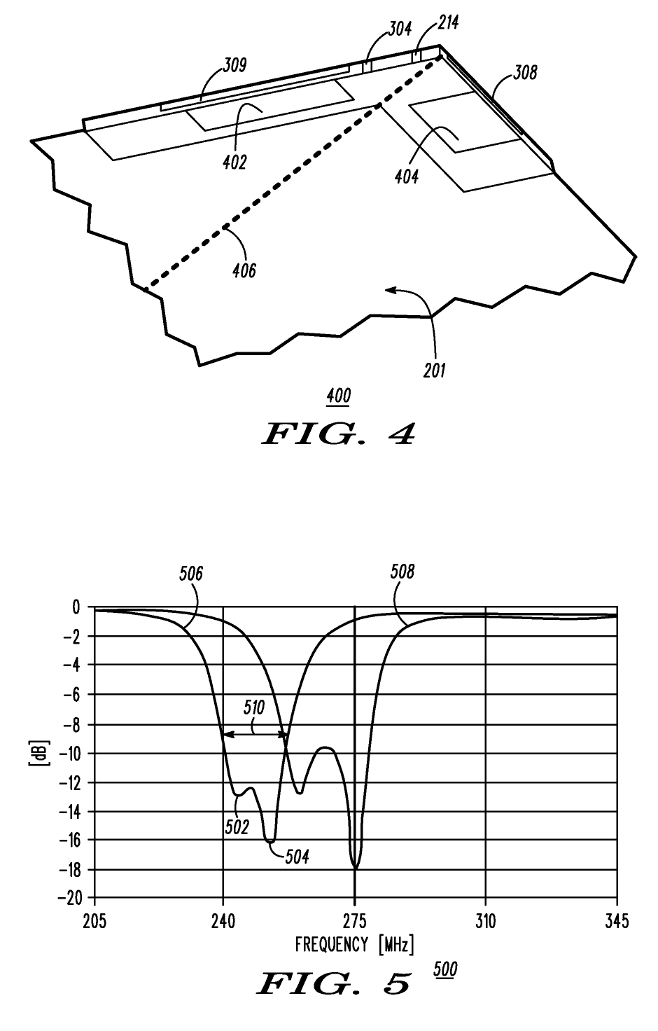

Referring to FIGS. 3 and 4, the parasitic conductor 208 is coupled to a first conductor 306 that couples the ground plane 201 to the parasitic conductor 208 by way of a via from the ground plane 201 to an edge of the parasitic conductor 208. Similarly, the active conductor 206 is coupled to a second conductor 304 that couples the ground plane 201 to the active conductor 206 by way of another via from the ground plane 201 to an edge of the active conductor 206 as shown in FIG. 3. Further the active conductor 206 is coupled to a signal feed conductor 214 shown in FIG. 2 as a trace coupled by way of the multilayer PCB 202 to a component of the transceiver 104.

The signal feed conductor 214 is proximately positioned to the first conductor 306 to excite the resonant frequency of the parasitic conductor 208 as shown in FIG. 3. By coupling reactive switching elements 212 to the active and parasitic conductors 206-208 a frequency spectrum of the antenna 102 can be shifted in frequency when the reactive elements are engaged or disengaged. In an embodiment in which the reactive element is capacitive the frequency spectrum of the antenna 102 is shifted down when the capacitive switching elements are engaged, and up when the capacitive elements are disengaged. The opposite is true if the reactive elements are inductive. Moreover, the reactive switching elements can be a bank of capacitive and/or inductive elements (not shown) so that the reactance can be varied as well. In the present context, a switching element can also represent a varactor that can be used to vary capacitance by way of a bias voltage.

Other devices such Micro-Electrical Mechanical (MEM) devices can be used also to represent a variable reactive switching element. Thus, any device that can vary reactance can be used as a switching element in the present disclosure. For the present illustrations, the reactive switching elements will be assumed to be capacitive. In this case, capacitive switching elements 212 can have the same capacitance when coupled between the active and parasitic conductors 206-208. Alternatively, the capacitive switching elements 212 can have dissimilar capacitances when coupled between the active and parasitic conductors 206-208.

FIG. 5 provides a spectral depiction of the performance of some embodiments of the antenna 102. A first spectrum 506 represents the capacitive switching elements engaged, while a second spectrum 508 represents the capacitive switching elements disengaged. The active and parasitic conductors 206 as described in FIGS. 2 and 3 produce a spectral effect consisting of an active resonant frequency response 502 and a parasitic resonant frequency response 504 that together provide a wide operating bandwidth 510 corresponding to a return loss of −10 dB or less.

There are a number of variables in the illustrations of FIGS. 2-4 that can affect the spectral performance of the antenna 102. For example, referring back to FIG. 3 as a separation 316 between the signal feed conductor 214 and the first conductor 306 having a coupling distance therebetween decreases the active and parasitic resonant frequencies 502-504 move closer to each other, and vice-versa. If the separation 316 between the signal feed conductor 214 and the first conductor 306 becomes too small the active and parasitic resonant frequencies 502-504 collapse into a single resonant frequency response. A designer of the antenna 102 can thus vary the separation 316 between the signal feed conductor 214 and first conductor 306 to select an appropriate spectral shape for the antenna 102.

Additionally, to increase the operating bandwidth 510 of the antenna 102, portions of the ground plane 201 below the active and parasitic conductors 206-208 can be removed. The removal of these portions is illustrated as slots 402-404 in FIG. 4. As the surface area of slots 402-404 increases the operating bandwidth increases, and vice-versa. Slots 402-404 provide the designer yet another spectral factor to vary in the design of the antenna 102. Slots 402-404 can have a uniform (i.e., consistent) or non-uniformed (i.e., inconsistent) surface geometry with similar spectral performance. In yet another embodiment, an increase in a diagonal length 406 of the ground plane 201 can increase the operating bandwidth 510 of the antenna 102, and vice-versa.

Similarly, the designer can change the length and/or width of the active and parasitic conductors 206-208. As the length increases for instance the spectrum 506 (or 508) shifts down in frequency, and vice-versa. The same is true to a lesser extent when varying the width of said conductors 206-208.

To accommodate compact housing assemblies of the communication device 100, the signal feed conductor 214, and the first and second conductors 304,306 can be located at an edge farthest from the opposing respective longitudinal ends 312-314 of the active and parasitic conductors 206-208. Such placement allows for a shorter length for each of the active and parasitic conductors 206-208 without foregoing a desired spectral performance.

A separation 318 between the signal feed conductor 214 and the second conductor 304 has a coupling distance therebetween that serves yet as another design variable. As the separation between these conductors increases so does the matching impedance to the transceiver 104. The inverse is also true. In practice, the separation between the signal feed conductor 214 and the second conductor 304 can be chosen to achieve approximately a 50 Ohm impedance.

In yet another embodiment, referring back to FIG. 3, portions 308, 309 of each of the active and parasitic conductors 206-208 can bend over an edge of the insulating spacers 310 in a vicinity of slots 402-404 (see FIG. 4). These portions (or skirts) can be used to tune the quality (or Q) factor of the antenna 102. The skirts 308, 309 draw the electric field of the active and parasitic conductors 206-208 towards slots 402-404 thereby reducing the Q factor of the antenna 102, which in turn widens the operating bandwidth of the antenna 102.

The foregoing embodiments of the antenna 102 illustrated in FIGS. 2-4 provide a low profile internal antenna design with a wide operating bandwidth. The specification and figures are to be regarded in an illustrative rather than a restrictive sense, and all modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An antenna, comprising:
a ground structure;
an active conductor characterized as a first resonance element supported on the ground structure by a first insulating spacer;
a parasitic conductor characterized as a second resonance element supported on the ground structure by a second insulating spacer;
a first slot between the active and parasitic conductors forming a gap and a corresponding coupling region;
a first conductor coupling the ground structure to the parasitic conductor near the coupling region;
a second conductor coupling the ground structure to the active conductor near the coupling region; and
a signal feed conductor coupling to the active conductor near the coupling region, wherein the signal feed conductor has a first separation from the first conductor and a second separation from the second conductor.

2. The antenna of claim 1, comprising:
a first reactive switching element coupled to the parasitic conductor; and
a second reactive switching element coupled to the active conductor, wherein the antenna has a frequency spectrum comprising an active resonant frequency response and a parasitic resonant frequency response having an operating bandwidth therebetween, wherein the frequency spectrum is shifted when the first and second reactive switching elements are reactively engaged with or disengaged with the parasitic and active conductors.

3. The antenna of claim 2, wherein the first and second reactive switching elements comprise first and second capacitors coupled between the active and parasitic conductors and the ground structure by way of first and second switches, and wherein a variance in the capacitance of the first and second capacitors shifts the frequency spectrum.

4. The antenna of claim 2, wherein the first and second reactive switching elements have similar reactance.

5. The antenna of claim 2, wherein the first and second reactive switching elements have dissimilar reactance.

6. The antenna of claim 1, comprising a substrate for supporting the ground structure, wherein the substrate comprises a printed circuit board (PCB), wherein the ground structure has a rectangular geometry extending throughout a substantial portion of the PCB, and wherein the antenna is located near a corner of said rectangular geometry.

7. The antenna of claim 6, wherein a change in a diagonal length of the ground structure shifts a frequency spectrum of the antenna.

8. The antenna of claim 1, wherein the first separation between the signal feed conductor and the first conductor has a coupling distance that produces a frequency spectrum comprising an active resonant frequency response and a parasitic resonant frequency response having an operating bandwidth therebetween.

9. The antenna of claim 1, wherein the second separation between the signal feed conductor and the second conductor has a coupling distance that produces a matching impedance for coupling the antenna to a communication circuit.

10. The antenna of claim 1, comprising:
a second slot located in the ground structure beneath the active conductor; and
a third slot located in the ground structure beneath the parasitic conductor, wherein changes in geometries of the second and third slots tune an operating bandwidth of the antenna.

11. The antenna of claim 10, wherein the second and third slots are characterized by a uniform geometry.

12. The antenna of claim 10, wherein a first portion of the active conductor bends over an edge of the first insulating spacer in a vicinity of the second slot, and wherein a second portion of the parasitic conductor bends over an edge of the second insulating spacer in a vicinity of the third slot, wherein changes in geometries of the first and second portions tune a resonance quality factor of the antenna.

13. The antenna of claim 1, wherein the active and parasitic conductors comprise elongated flat conductors having a length greater than its width, and wherein the signal feed conductor, and first and second conductors are located near ends of the active and parasitic conductors in a vicinity of the coupling region, wherein said ends are opposite to longitudinal ends of said active and parasitic conductors.

14. The antenna of claim 1, wherein the first slot is characterized by a uniform slot.

15. The antenna of claim 1, comprising a communication circuit coupled to the antenna for receiving and processing radio frequency (RF) signals in an operating bandwidth of the antenna.

16. The antenna of claim 1, comprising a communication circuit coupled to the antenna for transmitting radio frequency (RF) signals in an operating bandwidth of the antenna.

17. The antenna of claim 1, wherein the antenna has a frequency spectrum comprising an active resonant frequency response and a parasitic resonant frequency response having an operating bandwidth therebetween, and wherein a change in one among a length and width of the parasitic and active conductors shifts the frequency spectrum.

18. The antenna of claim 1, wherein the first and second insulating spacers comprise a dielectric material.

19. A communication device, comprising:
an antenna;
a communication circuit coupled to the antenna; and
a controller programmed to cause the communication circuit to process signals associated with a wireless communication system, and wherein the antenna comprises:
a ground structure;
an active conductor comprising a first elongated flat conductor having a length greater than its width and characterized as a first resonance element supported on the ground structure by a first insulating spacer;
a parasitic conductor comprising a second elongated flat conductor having a length greater than its width and characterized as a second resonance element supported on the ground structure by a second insulating spacer;
a first slot between the active and parasitic conductors forming a coupling region;
a first conductor coupling the ground structure to the parasitic conductor near the coupling region;
an second conductor coupling the ground structure to the active conductor near the coupling region; and
a signal feed conductor coupling to the active conductor near the coupling region.

20. A communication device, comprising: an antenna;
a communication circuit coupled to the antenna; and
a controller programmed to cause the communication circuit to process signals associated with a wireless communication system, and wherein the antenna comprises:
a ground structure supported by a PCB, wherein the ground structure has a rectangular geometry extending throughout a substantial portion of the PCB, and wherein portions of the antenna are located near a corner of said rectangular geometry;
a first elongated flat conductor having a length greater than its width supported on the ground structure by a first insulating spacer;
a second elongated flat conductor having a length greater than its width supported on the ground structure by a second insulating spacer;
a first reactive switching element coupled to the first elongated flat conductor;
a second reactive switching element coupled to the second elongated flat conductor;
a first slot between the first and second elongated flat conductors forming a coupling region;
a first conductor coupling the ground structure to the first elongated flat conductor near the coupling region;
an second conductor coupling the ground structure to the second elongated flat conductor near the coupling region; and
a signal feed conductor coupling to the first elongated flat conductor near the coupling region.
